(19) United States
(12) Patent Application Publication
(10) Pub. No.: US 2007/0272300 A1
(43) Pub. Date: Nov. 29, 2007

(54) Plated fire hydrant rod

(76) Inventors: Thomas Dewey Davidson, Griffin, GA (US); Matthew Jesse Rose, Macon, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/441,553

(22) Filed: May 26, 2006

(51) Int. Cl. F16K 17/40

(52) U.S. Cl. 137/68.14

(57) ABSTRACT

Various aspects and embodiments of the present invention provide a fire hydrant actuator rod that is a corrosive resistant rod made by a cold-rolled finish process and plated with a metal compound. An actuator rod of the present invention may be installed in a fire hydrant between the cap structure and valve and cooperate with an O-ring and/or hydrant component to provide a seal without a sleeve or inner O-ring. In some embodiments of the present invention, an actuator rod is provided that cooperates with an O-ring to form a seal at the fire hydrant cap structure.

### FIELD OF INVENTION

Various aspects and embodiments of the present invention relate to fire hydrant rods configured to cooperate with an O-ring to form a seal at various points along the rod.

### BACKGROUND OF THE INVENTION

Fire hydrants generally provide access to a water supply and more particularly provide water to, among other things, fight fires. Conventional fire hydrants include a valve at a water conduit, a barrel to provide a pathway for the water from the conduit to flow when the valve is opened, a nozzle to provide access to the barrel interior, a bonnet or cap structure with a nut, an actuator rod from the cap structure to the valve for opening the valve, and a breakaway between the cap structure and valve to provide a breakaway point if a car or other object hits the fire hydrant.

Conventional actuator rods are generally made from hot-rolled finish steel and are connected to the cap structure, breakaway and valve with an O-ring and a brass sleeve. Steel is an iron-based metal alloy that may be plastically formed, such as by rolling and pounding. Steel alloy may include iron and carbon. The carbon may be replaced and/or supplemented with other alloying materials.

Hot-rolling is a relatively inexpensive process in which the steel is passed through a pair of rolls when the temperature of the metal is above its recrystallization temperature. A recrystallization temperature is the point at which the steel molecules are packed close together, thereby creating a new crystal structure but keeping the same composition. The recrystallization temperature may depend upon, in part, the material's percentage of carbon or other material. The load applied by the rolls may be controlled, as desired. Hot-rolling results in the physical alteration of the shape of the steel with a relatively low number of rolling cycles and without substantially modifying the micro-structural properties.

Hot-rolled finish steel, however, generally has a finish or surface condition that is not conducive to providing a seal. For example, the steel rod may have an inconsistent and uneven surface with, generally, a surface roughness with a root mean square value (RMS) greater than 250 micro-inches. RMS value reflects surface roughness or smoothness properties of a metal or other surface according to the magnitude of physical variations or irregularities on the surface. RMS value may be measured using the following standard, which is incorporated herein by this reference: ASME B46.1-2002, “Surface Texture, Surface Roughness, Waviness and Lay,” ISBN 0791828018. Therefore, an O-ring and brass sleeve are necessary to provide a seal between the actuator rod and cap structure and/or other hydrant components.

In some conventional fire hydrants, a stainless steel actuator rod may be used. Stainless steel is a ferrous alloy, generally with a minimum of 10.5% chromium content. The stainless steel rod, however, is relatively expensive, may not include a hard-coat finish, and may not provide desired lubricity characteristics for use in a fire hydrant. Lubricity describes the slipperiness or smoothness of a material. Relatively high lubricity is a desirable characteristic for fire hydrant actuator rods since actuator rods generally cooperate with moving parts and form a seal to protect fire hydrant components.

In FIG. 1, illustrated is one embodiment of a conventional fire hydrant 10 having a barrel 12, nozzle 14, cap structure 16, breakaway structure 18, and a valve 20. The fire hydrant 10 also includes a hot-rolled steel actuator rod 22 inserted into a brass sleeve 24 with an inner O-ring 26 between the brass sleeve 24 and actuator rod 22. A second O-ring 28 is located at the appropriate fire hydrant component, such as the cap structure 16. To install the hot-rolled actuator rod 22, the brass sleeve 24 and inner O-ring 26 are connected to the actuator rod 22. The actuator rod 22 is then connected to second O-ring 28. The resulting structure is connected to a hydrant component, such as the cap structure 16 to form a seal.

The cap structure 16 and/or valve 20, however, may exert pressure on the brass sleeve 24, particularly when the actuator rod 22 is rotated using a cap structure nut 30. The pressure may cause the brass sleeve 24 to lose its integrity or break and allow water, or other liquids, to bypass the seal and cause the components to rust or fail. In addition, oil, located in the cap structure and/or other areas of the hydrant to prevent the hydrant components from rusting and provide lubrication, may leak out.

Consequently, a need exists for a fire hydrant rod that does not need a brass sleeve or inner O-ring but that nevertheless has a composition, structure and/or surface roughness that allows it to be able to form an adequate seal with the fire hydrant cap structure, fire hydrant valve, or moving fire hydrant components such as a secondary valve to prevent backflow. Furthermore, a need exists for a non-corrosive rod that will not lose its integrity or corrode after being exposed to water. A need also exists for a fire hydrant rod having a high lubricity characteristic to cooperate with fire hydrant components and form a seal with an O-ring.

### SUMMARY

Accordingly, various aspects and embodiments of the present invention provide a fire hydrant actuator rod that is a corrosive resistant rod with a high lubricity characteristic and appropriate surface roughness characteristics, composition and structure made by a cold-rolled finish process and plated with a metal compound. An actuator rod according to some embodiments of the present invention may be installed in a fire hydrant between the cap structure and valve and cooperate with an O-ring to provide a seal without a sleeve or inner O-ring. In some embodiments of the present invention, an actuator rod is provided that cooperates with an O-ring to form a seal at the fire hydrant cap structure. The actuator rod may also form a seal at a fire hydrant secondary valve.

Various aspects and embodiments of the present invention provide an actuator rod made by a cold-rolled finish process and plated with a metal to form a rod having a surface with a consistent and smooth finish. In some embodiments of the present invention, the metal used to plate the rod is nickel. The rod may also be polished to ensure a consistent finish. According to some embodiments of the present invention, the actuator rod may be made from cold-rolled steel.

### BRIEF DESCRIPTION OF THE DRAWINGS

FIG. 1 illustrates a cross-sectional view of a conventional fire hydrant having an actuator rod with a brass sleeve and inner and outer O-ring components.

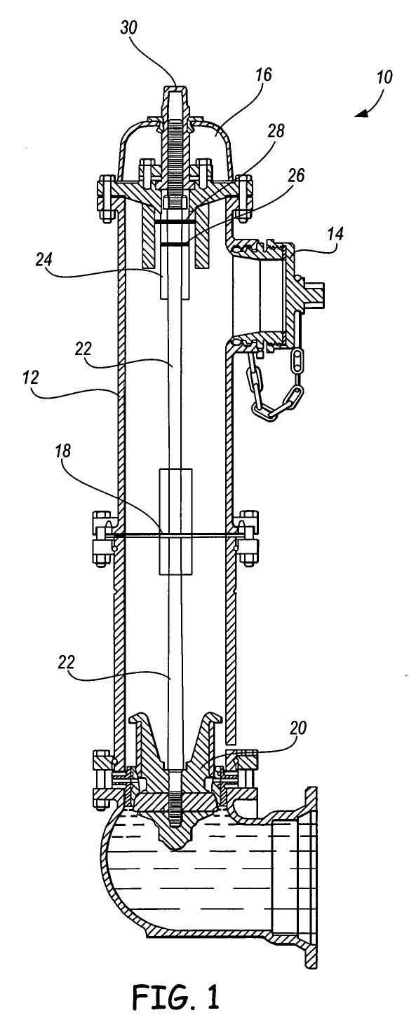

FIG. 2 is a cross-sectional view of a cold-rolled fire hydrant actuator rod according to one embodiment of the present invention.

FIG. 3 is a cross-sectional view of a fire hydrant with an actuator rod forming a seal at the cap structure according to one embodiment of the present invention.

### DETAILED DESCRIPTION

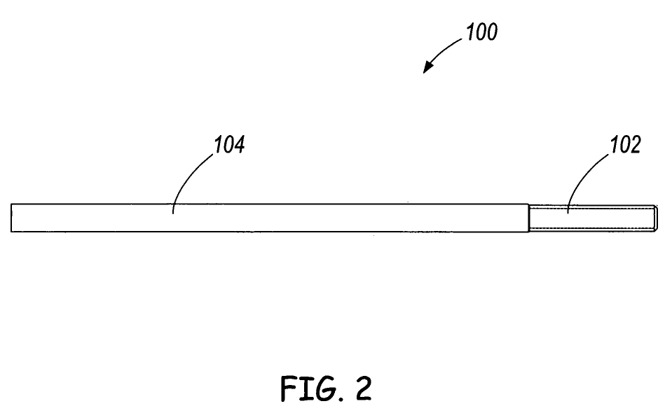

FIG. 2 shows a fire hydrant actuator road 100 adapted to be installed in a fire hydrant according to one embodiment of the present invention. The actuator rod 100 may include a first end 102 and a second end 104. The first end 102 preferably has a slightly smaller diameter than the second end 104 for cooperation with a fire hydrant cap structure. Furthermore, the first end 102 may be threaded and/or connected to a fire hydrant cap structure. In one embodiment of the present invention, the actuator rod 100 is an original equipment manufacture (OEM) rod. The actuator rod 100 may be preferably made by cold-rolling a metal, such as steel, to a desired diameter. Generally, cold-rolling is a fabricating process in which a material, such as metal, is passed through a pair of rolls. In a profile rolling process, the resulting object may be a round rod or other shaped bar. The cold-rolled process may include extruding steel through dies, resulting in a metal bar or rod having specific standards. One example is a steel bar or rod according to American Standard for Testing and Materials (ASTM) A108-03e1 (incorporated herein by this reference) which is a cold-rolled finish carbon and alloy steel bar produced in straight length and coil.

After the cold-rolled process, the diameter of the actuator rod 100 may be further reduced to a desired diameter by, for example, machining, polishing or other surface treatment. Alternatively or in addition, the actuator rod 100 may be plated with a substance, such as metal, to form an actuator rod 100 with a corrosive resistant surface and a relatively smooth surface conducive to forming a seal with desired fire hydrant components, with or without using a sleeve. Plating the actuator rod with a metal, such as nickel or zinc alloys, may be accomplished by a number of methods. One example is an electroless (also known as chemical or autocatalytic) method in which the metal to be plated, for example nickel alloy, is suspended in a solution and deposited onto the cold-rolled finish steel, due to a chemical reaction, when the cold-rolled finish steel is introduced into the solution. In some embodiments of the present invention, the coatings may include a nickel-phosphorus solution, nickel-boron solution, or a poly-alloy solution. For example, a solution of nickel-phosphorus may be utilized having a 3 to 13 percent phosphorus composition by weight in a solution of sodium hypophosphite and water at a temperature of 85 to 95 degrees Celsius. In preferred embodiments of the present invention a nickel-phosphorus solution having 9 to 12 percent composition by weight of phosphorus is used.

When the cold-rolled finish steel is introduced into the solution, a chemical reaction occurs forming a relatively uniform coating of plating and a surface with a relatively smooth finish. Preferably, the entire steel rod is introduced into the solution. In some embodiments of the present invention, a layer of nickel alloy is plated to the steel with a thickness of between 0.0005 to 0.0007 inches. After the metal is plated onto the cold-rolled finish steel, the surface preferably has a surface roughness with an RMS value of less than 65 micro-inches, using the standard, ASME B46.1-2002, “Surface Texture, Surface Roughness, Waviness and Lay,” thereby providing an actuator rod having a relatively smooth, corrosive resistant surface with a high lubricity characteristic.

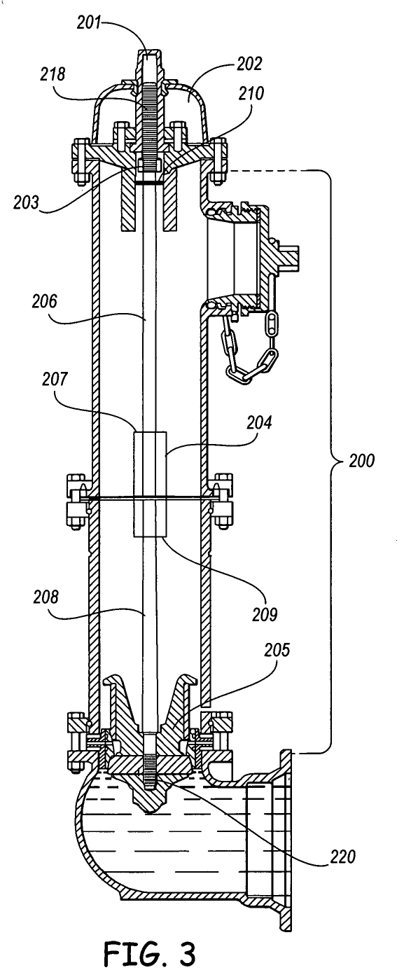

The actuator rod 100 may then be used to form a seal with an O-ring and a desired fire hydrant component without using a sleeve. As illustrated in FIG. 3, embodiments of an actuator rod 200 may be installed in a fire hydrant between a hydrant cap structure 202, breakaway structure 204 and a valve 205. The cap structure 202 may include an operating nut 201 and a bottom end 203. In preferred embodiments of the present invention, the actuator rod 200 includes a first rod 206 between the cap structure 202 and the breakaway structure 204 and a second rod 208 between the breakaway structure 204 and valve 205.

In one embodiment of the present invention, the actuator rod 206 may be installed by inserting a first end of the actuator rod 206 through a first O-ring 210. The first end of the actuator rod 206 may be coupled to the bottom end 203 of cap structure 202 and the second end of the actuator rod 206 may be coupled to a first end 207 of breakaway structure 204. The first end of actuator rod 206, in cooperation with the O-ring 210 and cap structure 202, preferably forms a seal such that solids or fluids are not allowed to reach the inner structure of cap structure 202.

Similarly, the second end of the actuator rod 208 may be coupled to the valve 205 and the first end of actuator rod 208 may be coupled to a second end 209 of breakaway structure 204. In some embodiments, the second end of actuator rod 208, in cooperation with valve 205, may form a seal without using a sleeve, such that solids or fluids are not allowed to reach the inner structure of valve 205.

The actuator rods 206, 208 are preferably coupled or connected, directly or indirectly, such that actuator rod 208 rotates when actuator rod 206 rotates. The operating nut 201 of cap structure 202 may be coupled or connected to the actuator rod 206, such that actuator rod 206 rotates when the operating nut 201 is rotated. In addition, the valve 205 may be coupled or connected to one end of actuator rod 208, such that the valve is opened and closed depending on the direction of rotation by the actuator rod 208. For example, the operating nut 201 may be rotated, such as by a wrench or other device, thereby causing the actuator rod 206 to rotate. The actuator rod 208 also rotates and the valve 205 may be opened and closed.

In some embodiments of the present invention, one or more ends of the actuator rods 206, 208 may be threaded 218, 220 to couple the rod with the desired hydrant component. The actuator rods 206, 208 may cooperate with hydrant components, such as the cap structure 202 and/or a secondary valve in the hydrant to prevent backflow (not shown), to form a seal and/or allow hydrant components to slide along the surface of the actuator rods 206, 208.

In some embodiments of the present invention, the actuator rods 206, 208 may be coupled to hydrant components without sleeves to form a seal at hydrant component 202 or other moving hydrant components such as a secondary valve to prevent backflow.

In some embodiments of the present invention, one actuator rod may be coupled to the cap structure 202, to form a seal, without using sleeves, at hydrant component 202 or other moving hydrant components such as a secondary valve to prevent backflow.

The foregoing description of embodiments of the invention has been presented only for the purpose of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated.

What is claimed is:

1. A fire hydrant comprising:
a barrel adapted to communicate at least indirectly with a water conduit, the barrel comprising an interior cavity;
a nozzle extending from the barrel and providing access to the barrel interior;
a hydrant valve adapted to controllably restrict communication between the barrel and the water conduit;
a cap structure having a housing cover, an operating nut, and a bottom end;
a breakaway structure located in the interior cavity between the cap structure and hydrant valve;
an actuator rod made from a cold-rolled finish process and extending from said cap structure to said valve, at least a portion of the actuator rod having a surface roughness with a root mean square value of less than 65 micro-inches; and
wherein said actuator rod cooperates with an O-ring to form a seal.

2. The fire hydrant of claim 1, wherein the rod cooperates with an O-ring, and not a metallic sleeve, to form a seal.

3. The fire hydrant of claim 1, wherein the rod member comprises a first member between said cap structure and said breakaway structure and a second member between said breakaway structure and said valve.

4. The fire hydrant of claim 3, wherein said first rod member cooperates with an O-ring, and not a metallic sleeve, to provide a seal at said cap structure bottom.

5. The fire hydrant of claim 3, wherein at least a portion of said first rod member has a surface roughness root mean square value of less than 65 micro-inches.

6. The fire hydrant of claim 1, wherein at least a portion of the rod is corrosive resistant.

7. The fire hydrant of claim 6, wherein said second rod member cooperates with said breakaway structure second end.

8. The fire hydrant of claim 3, wherein said second rod member cooperates with said hydrant valve.

9. The fire hydrant of claim 3, wherein said first rod members is made from metal plated, cold-rolled steel.

10. The fire hydrant of claim 9, wherein said metal is nickel alloy.

11. A method for using a fire hydrant rod in a fire hydrant comprising a cap structure, breakaway structure, and a valve, the method comprising:
providing a first O-ring;
providing a rod member made from a cold-rolled finish process having a first end and a second end, the rod member having a surface roughness with a root mean square value of less than 65 micro-inches;
plating at least a portion of said rod with a metal;
associating said first O-ring with said rod member first end;
coupling said rod member first end to said cap structure;
coupling said rod member second end to said breakaway structure; and
wherein the rod member first end cooperates with an O-ring, and not a sleeve, to form a seal at said cap structure.

12. The method of claim 11, further comprising polishing said rod member.

13. The method of claim 11, wherein said breakaway structure further comprises a first end and a second end.

14. The method of claim 13, further comprising:
providing a first rod member made from a cold-rolled process and having a first end and a second end;
providing a second rod member having a first end and a second end;
coupling the first rod member first end to the cap structure;
coupling the first rod member second end to the breakaway structure first end;
coupling the second rod member first end to the breakaway structure second end;
coupling the second rod member second end to the valve; and
wherein the first rod member first end cooperates with the first O-ring, and not a sleeve, to form a seal.

15. The method of claim 11, wherein said metal is nickel alloy.

16. The method of claim 11, wherein said metal is zinc alloy.

17. A method for making a seal at a fire hydrant cap structure comprising a nut and a bottom end, the method comprising:
providing an O-ring;
providing a rod member made from a cold-rolled finish process, the rod member having a root mean square value of less than 65 micro-inches;
plating at least a portion of the rod with a metal;
associating the O-ring with the rod member;
coupling the rod member to one or more hydrant components; and
wherein the rod member cooperates with the O-ring, and not a sleeve, to form a seal at the bottom end of the cap structure.

18. The method of claim 17 further comprising polishing said rod member.

19. The method of claim 17 wherein said metal is nickel alloy.

20. The method of claim 17, wherein said rod is a zinc alloy.
